(19) United States
(12) Patent Application Publication
(10) Pub. No.: US 2026/0330735 A1
(43) Pub. Date: Oct. 22, 2026

(54) INFORMATION PROCESSING DEVICE, INFORMATION PROCESSING METHOD, AND PROGRAM

(71) Applicant: Sony Group Corporation, Tokyo (JP)

(72) Inventors: Yuki TANAKA, Tokyo (JP); Nobuhiro SAIJO, Tokyo (JP); Keita MOCHIZUKI, Tokyo (JP)

(73) Assignee: Sony Group Corporation, Tokyo (JP)

(21) Appl. No.: 19/112,264

(22) PCT Filed: Aug. 29, 2023
(86) PCT No.: PCT/JP2023/031239

§ 371 Date: Mar. 17, 2025

(30) Foreign Application Priority Data
Oct. 7, 2022 (JP) 2022-162381

(51) Int. Cl. G06T 13/40

(52) U.S. Cl. CPC G06T 13/40

(57) ABSTRACT

An information processing device including circuitry configured to obtain interpolation motion data that interpolates between first motion data and second motion data that are temporally and spatially independent, and calculate an index related to motion velocity of each motion data based on the first motion data, the second motion data, and the obtained interpolation motion data.

### CROSS REFERENCE TO RELATED APPLICATIONS

This application claims the benefit of Japanese Priority Patent Application JP 2022-162381 filed on Oct. 7, 2022, the entire contents of which are incorporated herein by reference.

### TECHNICAL FIELD

The present disclosure relates to an information processing device, an information processing method, and a program.

### BACKGROUND ART

In recent years, animation production and distribution using motion capture for acquiring motion information indicating user's motion have been actively performed. For example, motion data imitating user's motion is generated using motion information acquired by motion capture, and an avatar video based on the motion data is delivered.

From such a background, the amount of motion data is increasing year by year, and technologies for reusing motion data generated so far have been developed. For example, Patent Literature 1 discloses a technique of blending movements of a plurality of pieces of motion data and reproducing the movement obtained by the blending in real time by an avatar or the like on a virtual space.

### CITATION LIST

### Patent Literature

PTL 1: WO 2019/203190 A

### SUMMARY

### Technical Problem

In a case where such a plurality of pieces of motion data is connected, an interpolation editing for more naturally connecting the plurality of pieces of motion data may be demanded. In such an interpolation editing, the parameters such as boundary conditions may be specified in detail, but it may be difficult for a user to set all parameters.

Therefore, the present disclosure proposes a new and improved information processing device, an information processing method, and a program capable of more naturally connecting the plurality of pieces of motion data.

### Solution to Problem

According to the present disclosure, an information processing device is provided that includes circuitry configured to obtain interpolation motion data that interpolates between first motion data and second motion data that are temporally and spatially independent, and calculate an index related to motion velocity of each motion data based on the first motion data, the second motion data, and the obtained interpolation motion data.

Furthermore, according to the present disclosure, an information processing method executed by a computer is provided that includes obtaining the interpolation motion data interpolating between temporally and spatially independent first motion data and second motion data, and calculating an index related to motion velocity of each motion data based on the first motion data, the second motion data, and the obtained interpolation motion data.

In addition, according to the present disclosure, a non-transitory computer-readable storage medium having embodied thereon a program, which when executed by a computer causes the computer to execute a method, the method including obtaining interpolation motion data that interpolates between temporally and spatially independent first motion data and second motion data, and calculating an index related to motion velocity of each motion data based on the first motion data, the second motion data, and the obtained interpolation motion data.

### BRIEF DESCRIPTION OF DRAWINGS

FIG. 1 is an explanatory diagram for describing an information processing system according to an embodiment of the present disclosure.

FIG. 2 is an explanatory diagram for describing an example of a functional configuration of a server 10 according to an embodiment of the present disclosure.

FIG. 3 is an explanatory diagram for describing an example of a functional configuration of a PC 20 according to an embodiment of the present disclosure.

FIG. 4A is an explanatory drawing for describing an example of motion data connection processing.

FIG. 4B is an explanatory drawing for describing an example of motion data connection processing.

FIG. 5 is an explanatory diagram for describing an overview regarding interpolation editing for interpolating between a plurality of pieces of motion data.

FIG. 6A is an explanatory diagram for describing motion blending as an example of interpolation editing.

FIG. 6B is an explanatory diagram for describing generation of interpolation motion data C as another example of interpolation editing.

FIG. 7 is an explanatory diagram for describing a specific example of processing in which a generation unit 241 according to an embodiment of the present disclosure generates interpolation motion data.

FIG. 8 is an explanatory drawing for describing a specific example of an interpolation parameter.

FIG. 9 is an explanatory drawing for describing an example of a GUI according to an embodiment of the present disclosure.

FIG. 10 is a flowchart for describing an example of operation processing of the PC 20 according to an embodiment of the present disclosure.

FIG. 11 is a block diagram illustrating a hardware configuration of the PC 20 according to an embodiment of the present disclosure.

### DESCRIPTION OF EMBODIMENTS

It should be understood by those skilled in the art that various modifications, combinations, sub-combinations and alterations may occur depending on design requirements and other factors insofar as they are within the scope of the appended claims or the equivalents thereof. Hereinafter, preferred embodiments of the present disclosure will be described in detail with reference to the accompanying drawings.

Note that, in the present specification and the drawings, components having substantially the same functional configuration are denoted by the same reference numerals, and redundant explanations are omitted.

Furthermore, the “Description of Embodiments” will be described according to the following order of items.
1. Outline of information processing system
2. Functional configuration example
2.1. Functional configuration example of server 10
2.2. Functional configuration example of PC 20
3. Details
3.1. Connection of motion data
3.2. Interpolation editing of motion data
3.3. Generation of interpolation motion data
3.4. Scoring
3.5. Graphical user interface (GUI)
4. Operation processing example
5. Example of action and effect
6. Modification example
7. Hardware configuration
8. Supplement

### 1. Outline of Information Processing System

As motion data, in order to visualize motion information of a moving body such as a human or an animal, for example, skeleton data represented by a skeleton structure indicating a body structure is used. The skeleton data includes information such as the position and posture of a part. More specifically, the skeleton data includes various types of information such as a global position of a root joint and a relative posture of each joint. Note that the part in the skeleton structure corresponds to, for example, an end part, a joint part, or the like of the body. Furthermore, the skeleton data may also include bones that are line segments connecting the parts. The bones in the skeleton structure may correspond to, for example, human bones, but the positions and number of the bones do not necessarily need to be matched with the actual human skeleton. Furthermore, the motion data may further include various types of information such as skeleton information indicating the length of each bone and the connection relationship with other bones, and time-series data of grounding information of both feet.

The position and posture of each part in the skeleton data can be acquired by various motion capture technologies. For example, there are a camera-type technology in which a marker is attached to each body part and the position of the marker is acquired using an external camera or the like, and a sensor-type technology in which a motion sensor is attached to a body part and position information of the motion sensor is acquired on the basis of time-series data acquired by the motion sensor.

In addition, the skeleton data has various uses. For example, the motion data that is time-series data of skeleton data is used for improving a form in dance or sports, or used for an application such as virtual reality (VR) or augmented reality (AR). Furthermore, an avatar video imitating the user's motion is generated using the motion data, and also the avatar video is distributed.

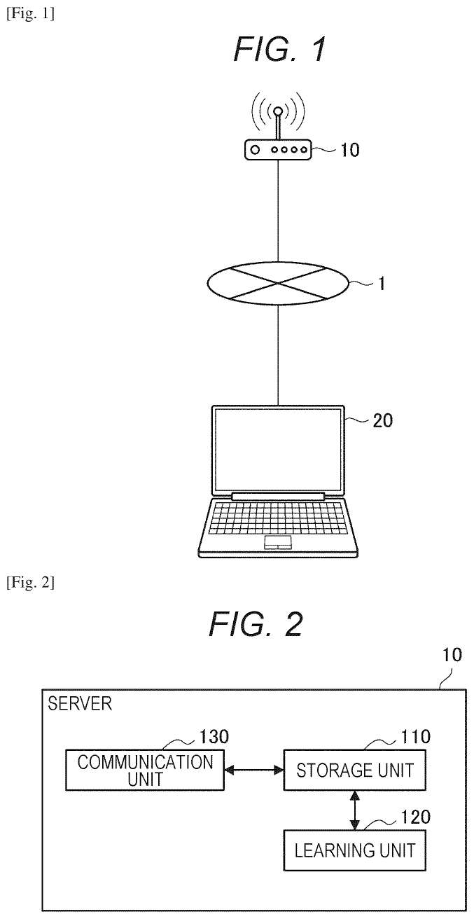

The information processing system according to an embodiment of the present disclosure enables a plurality of pieces of motion data to be more naturally connected. First, an outline of the information processing system will be described with reference to FIG. 1.

FIG. 1 is an explanatory diagram for describing an information processing system according to an embodiment of the present disclosure. As illustrated in FIG. 1, the information processing system according to the embodiment of the present disclosure includes a network 1, a server 10, and a personal computer (PC) 20.

### Network 1

The network 1 according to the embodiment of the present disclosure is a wired or wireless transmission path of information transmitted from a device connected to the network 1. For example, the network 1 may include a public network such as the Internet, a telephone network, or a satellite communication network, various local area networks (LANs) including Ethernet (registered trademark), a wide area network (WAN), and the like. In addition, the network 1 may include a dedicated line network such as an Internet protocol-virtual private network (IP-VPN). The server 10 and the PC 20 are connected via the network 1.

### Server 10

The server 10 according to the embodiment of the present disclosure is a device that holds a plurality of pieces of motion data. In addition, the server 10 learns a relationship between the two pieces of motion data and the parameter (hereinafter, it may be expressed as an interpolation parameter) related to motion and interpolation motion data, and acquires a generative model for generating the interpolation motion data.

### PC20

The PC 20 according to the embodiment of the present disclosure is an example of an information processing device, which acquires the interpolation motion data for interpolating between the two pieces of motion data, and calculates an index related to motion velocity of each motion data on the basis of the two pieces of motion data and the interpolation motion data.

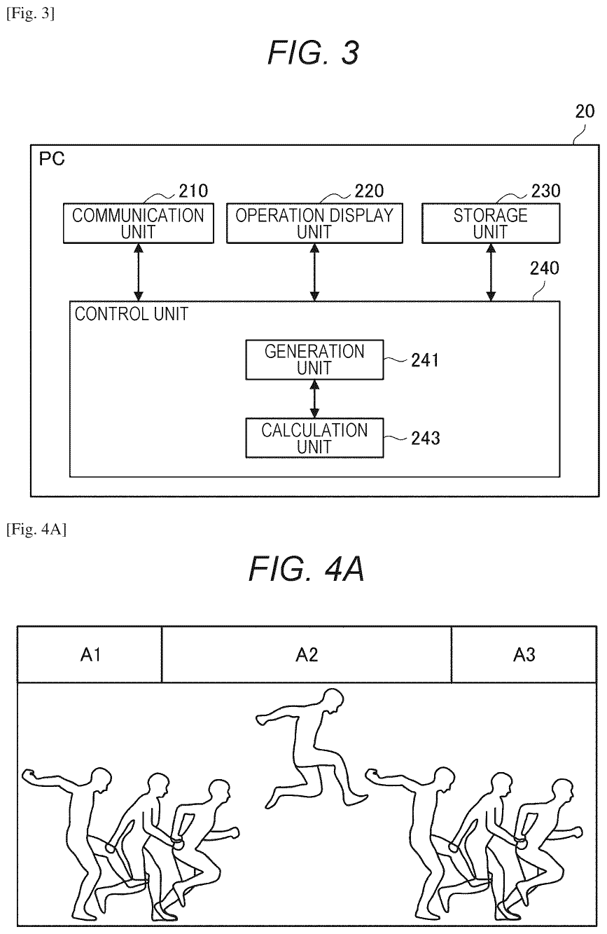

The outline of the information processing system according to the embodiment of the present disclosure has been described above. Next, details of functional configurations of the server 10 and the PC 20 will be sequentially described with reference to FIGS. 2 and 3.

### 2. Functional Configuration Example

### 2.1. Functional Configuration Example of Server 10

FIG. 2 is an explanatory diagram for describing an example of the functional configuration of the server 10 according to the embodiment of the present disclosure. As illustrated in FIG. 2, the server 10 according to the embodiment of the present disclosure includes a storage unit 110, a learning unit 120, and a communication unit 130.

### Storage Unit 110

The storage unit 110 according to the embodiment of the present disclosure holds software and various data. The storage unit 110 holds, for example, a plurality of pieces of motion data. Furthermore, the storage unit 110 may hold a generative model obtained by the learning unit 120.

### Learning Unit 120

The learning unit 120 according to the embodiment of the present disclosure learns a relationship between two pieces of temporally and spatially independent motion data and the interpolation parameter, and the interpolation motion data, and generates the generative model. Details regarding learning will be described later.

### Communication Unit 130

The communication unit 130 according to the embodiment of the present disclosure transmits and receives various types of information to and from the PC 20 via the network 1. The communication unit 130 receives, for example, request information for requesting motion data from the PC 20. Besides, the communication unit 130 transmits the motion data corresponding to the request information received from the PC 20 to the PC 20.

Further, the communication unit 130 may transmit the generative model held in the storage unit 110 to the PC 20.

An example of the functional configuration of the server 10 according to the embodiment of the present disclosure has been described above. Next, an example of the functional configuration of the PC 20 according to the embodiment of the present disclosure will be described with reference to FIG. 3.

### 2.2. Functional Configuration Example of PC 20

FIG. 3 is an explanatory diagram for explaining an example of the functional configuration of the PC 20 according to the embodiment of the present disclosure. As illustrated in FIG. 3, the PC 20 according to the embodiment of the present disclosure includes a communication unit 210, an operation display unit 220, a storage unit 230, and a control unit 240.

### Communication Unit 210

The communication unit 210 according to the embodiment of the present disclosure transmits and receives various types of information to and from the server 10 via the network 1. The communication unit 210 transmits, for example, request information for requesting motion data to the server 10. Then, the communication unit 210 receives the motion data transmitted according to the request information from the server 10.

Furthermore, the communication unit 210 may receive a generative model for generating interpolation motion data from the server 10.

### Operation Display Unit 220

The operation display unit 220 according to the embodiment of the present disclosure has a function as a display unit that displays the motion data received from the server 10 and various display information (for example, connected motion data or the like) generated by a generation unit 241 to be described later. In addition, the operation display unit 220 has a function as an input unit for the user to select the motion data. Note that when certain motion data is selected by the user, the communication unit 210 transmits request information for requesting the motion data to the server 10.

The function as the display unit is executed by, for example, a cathode ray tube (CRT) display device, a liquid crystal display (LCD) device, or an organic light emitting diode (OLED) device.

Furthermore, the function as the input unit is executed by, for example, a touch panel, a keyboard, or a mouse.

Note that in FIG. 1, the PC 20 has the configuration in which the functions of the display unit and the operation unit are integrated, but may have the configuration in which the functions of the display unit and the input unit are separated.

### Storage Unit 230

The storage unit 230 according to the embodiment of the present disclosure holds software and various data. The storage unit 230 holds the generative model received from the server 10. Furthermore, the storage unit 230 may hold interpolation motion data generated by the generation unit 241 described later. In addition, the storage unit 230 may hold the connected motion data obtained by connecting the interpolation motion data, the first motion data, and the second motion data generated by the generation unit 241.

### Control Unit 240

The control unit 240 according to the embodiment of the present disclosure controls the overall operation of the PC 20. As illustrated in FIG. 3, the PC 20 includes the generation unit 241 and a calculation unit 243.

The generation unit 241 according to the embodiment of the present disclosure is an example of an acquisition unit, and generates interpolation motion data that interpolates between the first motion data and the second motion data that are temporally and spatially independent. Details regarding the generation of the interpolation motion data will be described later.

For example, the generation unit 241 may input the first motion data, the second motion data, and at least one or more interpolation parameters regarding motion to the generative model to generate interpolation motion data. In addition, the generation unit 241 may generate interpolation motion data a plurality of times by correcting an interpolation parameter input to the generative model.

Furthermore, the generation unit 241 may generate connected motion data obtained by connecting the first motion data, the interpolation motion data, and the second motion data.

The calculation unit 243 according to the embodiment of the present disclosure calculates an index related to motion velocity of each motion data on the basis of the first motion data and the second motion data received by the communication unit 210 and the interpolation motion data generated by the generation unit 241. Details regarding the calculation of the index related to the motion velocity will be described later.

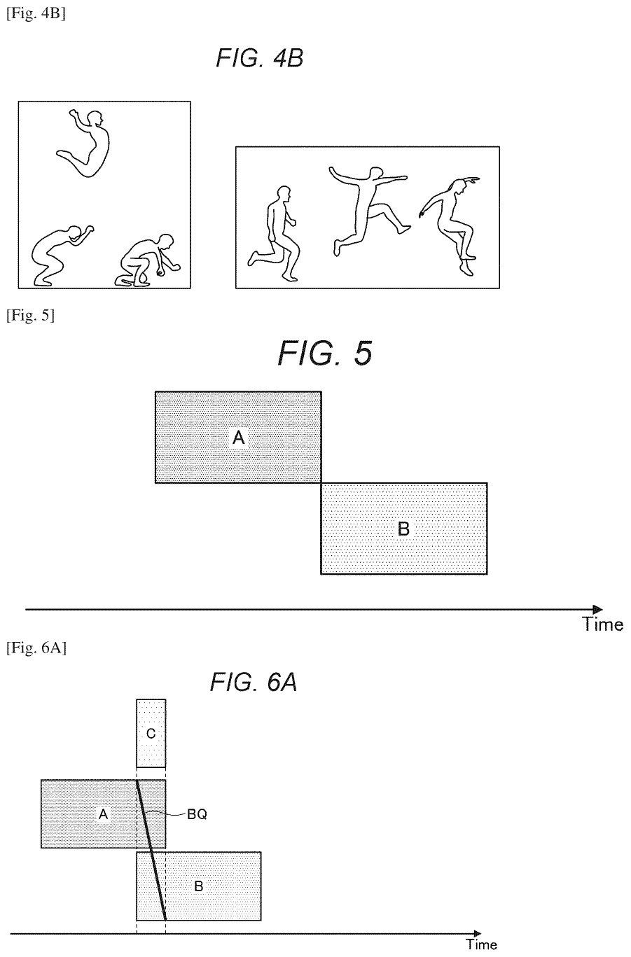

The details of the PC 20 according to the embodiment of the present disclosure have been described above. Next, details of the information processing system according to the embodiment of the present disclosure will be sequentially described with reference to FIGS. 4 to 9.

### 3. Details

Recently, there is an application in which motion data obtained by motion capture or manually is registered in a database, and the motion data is searched or edited in the database. For example, in editing of motion data, connection editing for connecting a plurality of pieces of the motion data may be demanded. First, a specific example of connection editing of a plurality of pieces of the motion data will be described with reference to FIG. 4.

### 3.1. Connection of Motion Data

FIG. 4 is an explanatory drawing for explaining an example of the motion data connection processing. Some sections included in certain motion data (hereinafter, expressed as first motion data A) may be replaced with other motion data (hereinafter, expressed as second motion data B) and corrected.

For example, the user who uses an application searches certain first motion data A, and selects the section A2 as the correction section among the plurality of sections A1 to A3 included in the first motion data A.

Then, the user selects the second motion data B as the correction target in the section A2. As a result, the section A2 of the first motion data A may be corrected by being replaced with the second motion data B to be corrected. Note that the second motion data B here may be any motion data selected on the application by the user, or may be motion data automatically selected by the application.

For example, as illustrated in FIG. 4, in a case where there are two pieces of second motion data B as candidates to be corrected for the section A2 of the first motion data A, the user selects one of the pieces of second motion data B. For example, in a case where the user selects the left diagram of the second motion data B illustrated in FIG. 4, the section A2 of the first motion data A is replaced with the left diagram of the motion data B illustrated in FIG. 4 and corrected.

However, if the section A2 of the first motion data A is simply replaced with the second motion data B, the motion is suddenly switched at the boundary portion between the first motion data A and the second motion data B. Therefore, the motion included in the motion data may be unnatural.

Note that the boundary portion here includes a portion that switches from the end position of the section A1 of the first motion data A to the start position of the second motion data B. In addition, the boundary portion includes a portion that switches from the end position of the second motion data B to the start position of the section A3 of the first motion data A.

Therefore, in the connection editing of such a plurality of pieces of motion data, it is desirable to perform interpolation editing for interpolating between the first motion data A and the second motion data B (i.e., the boundary portion).

The specific example related to the connection editing of the plurality of motion data has been described above. Next, a specific example of interpolation editing for interpolating between a plurality of pieces of motion data will be described.

### 3.2. Interpolation Editing of Motion Data

FIG. 5 is an explanatory diagram for describing an overview regarding the interpolation editing for interpolating between the plurality of pieces of motion data. For example, it is assumed that the first motion data A includes a walking motion and the second motion data B includes a kicking motion.

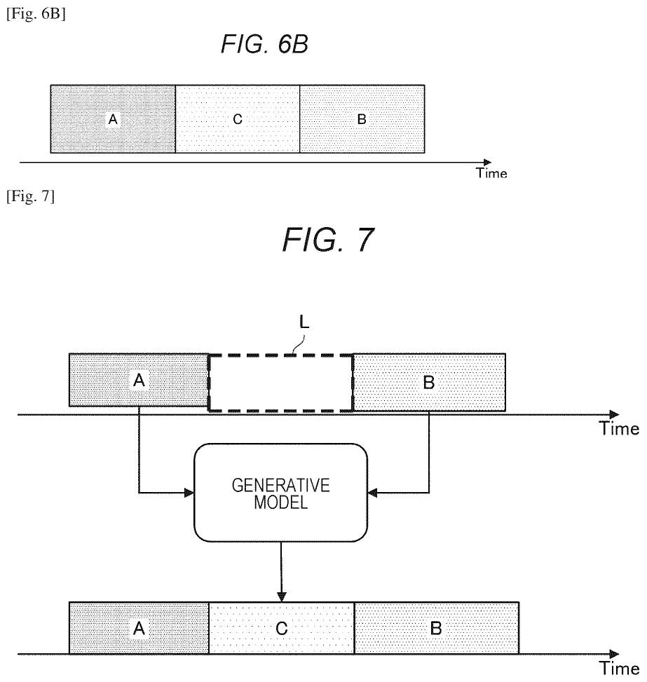

Here, when the motion data is suddenly switched from the first motion data A to the second motion data B as illustrated in FIG. 5, the motion is instantaneously switched from the walking motion to the kicking motion, so that the motion of the motion data may be unnatural. For example, since the joint position of each part included in the first motion data A transitions to the joint position of each part included in the second motion data B in one frame, a situation in which the position of a certain part instantaneously moves (warps) may occur. Therefore, the interpolation editing exists as a method to suppress unnatural motion that may occur in connection of such a plurality of pieces of motion data. Here, a specific example of the interpolation editing will be described with reference to FIGS. 6A and 6B.

FIG. 6A is an explanatory diagram for explaining motion blending as an example of the interpolation editing. For example, the motion blending is the interpolation editing that linearly and geometrically combines the first motion data A and the second motion data B.

In the interpolation editing by the motion blending, interpolation may be performed such that the motion included in the first motion data A gradually switches to the motion included in the second motion data B in an interpolation section BQ. Note that the motion data in which the motion is gradually switched in the interpolation section BQ is an example of the interpolation motion data C.

The motion blending can be used for the interpolation editing, which is suitable for situations of real-time performance being demanded even if some unnaturalness of movement remains. On the other hand, the interpolation editing by the motion blending may not be suitable for situations such as an animation editing in a case where more natural movement may be needed and there are many parameters related to interpolation.

FIG. 6B is an explanatory diagram for explaining generation of interpolation motion data C which is another example of interpolation editing. The generation of the interpolation motion data C includes, for example, generating of newly generating motion data using a machine learning technique such as deep learning. Here, the newly generated motion data is an example of the interpolation motion data C.

In the generation of the interpolation motion data C, although the number of parameters related to the interpolation is larger than that of the motion blending, the interpolation motion data C capable of interpolating between the first motion data A and the second motion data B with a more natural motion can be generated.

However, since there are many parameters related to the interpolation, it is difficult for a user to manually set all the parameters. In addition, the interpolation motion data C that naturally interpolates motion data is not necessarily generated from parameters set by the user. Furthermore, in a case where the parameter is automatically set, what kind of movement is desirable for the user also depends on preference of the user, and thus it is difficult to uniquely determine the movement at the time of setting the parameter.

Next, details of processing in which the generation unit 241 according to the embodiment of the present disclosure generates the interpolation motion data C will be described.

### 3.3. Generation of Interpolation Motion Data

FIG. 7 is an explanatory diagram for describing a specific example of processing in which the generation unit 241 according to the embodiment of the present disclosure generates interpolation motion data. First, as a preliminary preparation, the learning unit 120 included in the server 10 generates a generative model for generating the interpolation motion data C. For example, the learning unit 120 generates the generative model by machine learning using a set of two pieces of motion data that are temporally and spatially independent from each other, a parameter related to interpolation (hereinafter, referred to as an interpolation parameter), and the interpolation motion data as teacher data.

More specifically, as illustrated in FIG. 7, the learning unit 120 divides the motion data into three pieces having arbitrary lengths, and sets the motion data as first motion data A, second motion data B, and third motion data L, respectively. The lengths of the first motion data A, the second motion data B, and the third motion data L may be changed for each use case, or may be variable during learning of the generative model.

Subsequently, the learning unit 120 inputs the first motion data A, the second motion data B, and the interpolation parameter to the generative model. At this time, the third motion data L is regarded as lost (that means the third motion data L is not input to the generative model). As a result, the learning unit 120 generates a provisional generative model.

Next, the learning unit 120 calculates the loss between the interpolation motion data C generated from the first motion data A and the second motion data B, and the third motion data L (i.e., correct motion) using the generated generative model.

Then, the learning unit 120 may correct the parameter (for example, joint positions and joint postures, etc.) of the interpolation motion data so as to reduce the loss, repeatedly learn, and update the generative model. Then, the communication unit 130 included in the server 10 may transmit the generative model generated by the learning unit 120 to the PC 20.

Note that the learning unit 120 may generate the generative model from arbitrary motion data (a plurality of pieces of motion data including various motions), or may generate the generation model for each specific motion data such as walking or running.

Then, the generation unit 241 included in the PC 20 according to the embodiment of the present disclosure may generate the interpolation motion data C using a generative model G obtained from the server 10. More specifically, the generation unit 241 may generate an interpolation motion data x^{C} using the following formula (1).

### Math.1

x^{c}=G(x^{A}, x^{B}; c₀, c₁, c₂ . . . cₙ) (1)

It should be noted that, in the formula (1), x^{C} is the interpolation motion data, x^{A} is the first motion data, x^{B} is the second motion data, and c₀ to cₙ are the interpolation parameter.

The interpolation parameters are various parameters related to motion of motion data such as a boundary condition or a constraint condition, and may be set partially by the user, or may be automatically set on the basis of the first motion data A and the second motion data B.

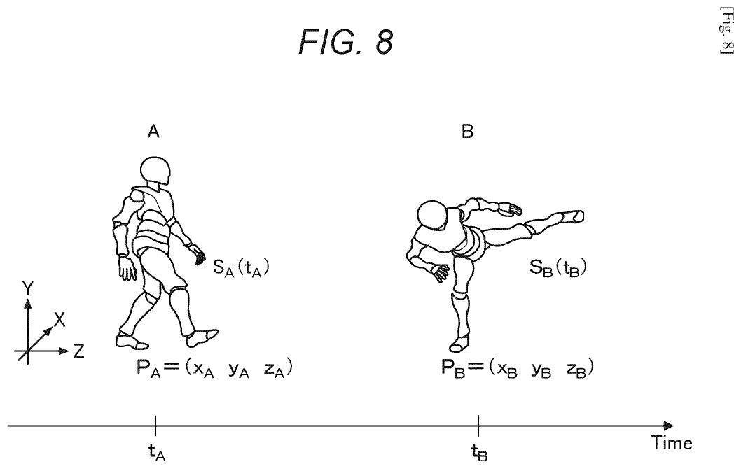

Here, a specific example of the interpolation parameter will be described with reference to FIG. 8.

### Interpolation Parameter

FIG. 8 is an explanatory drawing for describing a specific example of the interpolation parameter. FIG. 8 illustrates the situation in which the first motion data A and the second motion data B are temporally and spatially independent. Here, the spatial independence indicates a state in which the first motion data A and the second motion data B are spatially separated, and the temporal independence indicates a state in which the time from the start time to the end time of the first motion data A does not overlap the time from the start time to the end time of the second motion data B.

For example, the position of the motion data in the three-dimensional space is expressed by a position vector P. For example, the position of the first motion data A at the time t_{A} is expressed by P_{A}=(x_{A}, y_{A}, z_{A}). Furthermore, the position of the second motion data B at the time t_{B} is expressed by P_{B}=(x_{B}, y_{B}, z_{B}).

Note that the position of the motion data in the three-dimensional space may be, for example, the position of the root joint (waist joint) of the character, the position of another joint (for example, the joint of the toe), or the position calculated from the positions of a plurality of joints.

Furthermore, the posture of the motion data in the three-dimensional space is expressed by the all-joint posture S corresponding to the relative posture of all joints. For example, the position of the first motion data A at the time t_{A} is expressed by S_{A}(t_{A}). Furthermore, the posture of the second motion data B at the time t_{B} is expressed by S_{B}(t_{B}).

Various parameters may exist for the interpolation parameter. In this specification, eight kinds of parameters (A) to (H) are introduced, but other parameters may be included. In addition, some parameters among the parameters (A) to (H) may be manually specified by the user. In addition, all the parameters (A) to (H) may not be used for generating interpolation motion data. That is, some parameters of (A) to (H) may be input to the generative model.

### (A) Spatial Position

The interpolation parameter may include a parameter related to the spatial position of the motion data. For example, the parameter related to the spatial position is the distance in three-dimensional space between the first motion data A and the second motion data B. In other words, the parameter related to the spatial position is the difference between the spatial positions of the first motion data A and the second motion data B, and is represented by ||p_{A}-p_{B}||.

Here, the position p_{A} of the first motion data or the position p_{B} of the second motion data may be manually set by the user, or may be automatically set on the basis of the first motion data A and the second motion data B.

For example, the difference between the spatial positions may be set automatically on the basis of the estimation result by estimating the trajectory of the part or joint of the interpolation motion data by the velocity of each root joint of the first motion data A and the second motion data B.

### (B) Interpolation Time

The interpolation parameter may include the parameter related to an interpolation time interpolated by the interpolation motion data. The parameter related to the interpolation time is the time difference on the timeline of the first motion data A and the second motion data B, and is represented by t_{B}-t_{A}.

In addition, the end time of the first motion data A or the start time of the second motion data B may be manually set by the user, or may be automatically set.

For example, the interpolation time may be automatically set on the basis of the difference between the velocity or the spatial position of the root joint of the first motion data A and the second motion data B.

### (C) Posture of First Motion Data A (Interpolation Start Posture, Boundary Condition)

The interpolation parameter may include the parameter related to the posture of the first motion data A. The parameter related to the posture of the first motion data A is the parameter for adjusting the posture at the interpolation start time to by trimming the motion data A after the interpolation start time t_{A}, and is represented by S_{A}(t_{A}). By adjusting the parameter related to the posture of the first motion data A, the posture of the interpolation motion data C at the start of interpolation can be made more natural.

Furthermore, the parameter regarding the posture of the first motion data A may be automatically set on the basis of the most stable posture as the interpolation start posture estimated from the velocity of the root joint of the first motion data A.

### (D) Posture of Second Motion Data B (Interpolation End Posture, Boundary Condition)

The interpolation parameter may include the parameter related to the posture of the second motion data B. The parameter related to the posture of the second motion data B is the parameter for adjusting the posture at the interpolation end time t_{B} by trimming the motion data B before the interpolation end time t_{B}, and is represented by S_{B}(t_{B}). By adjusting the parameter related to the posture of the second motion data B, the posture of the interpolation motion data C at the end of interpolation can be made more natural.

Furthermore, the parameter regarding the posture of the second motion data B may be automatically set on the basis of the most stable posture as the interpolation end posture estimated from the velocity of the root joint of the second motion data B.

### (E) Contact Conditions

The interpolation parameter may include a parameter related to a contact condition. The parameter related to the contact condition may be the parameter related to contact with the ground, such as how many steps to take from the interpolation start time t_{A} to the interpolation end time t_{B}.

For example, the parameter related to the contact condition may be designated as “n steps” throughout the interpolation time from the interpolation start time t_{A} to the interpolation end time t_{B}. For example, in a case where a parameter related to the contact condition of “five steps” is set throughout the interpolation time, interpolation motion data C for walking five steps from the interpolation start time t_{A} to the interpolation end time t_{B} is generated.

Furthermore, in a case where the state in which the foot is in contact with the ground is “1” and the state in which the foot is not in contact with the ground (i.e., the foot is away from the ground) is “0”, the parameter regarding the contact condition may be sequentially designated at each time t between t_{A} and t_{B}, such as c(t)={0,1}. For example, in a case where the parameter related to a contact condition of “c(t₁)={0,1}” is set, interpolation motion data C in which the toe of the left foot is not in contact with the ground and the toe of the right foot is in contact with the ground is generated at time t₁.

In addition, a more appropriate number of steps may be estimated from the difference in spatial position between the first motion data A and the second motion data B or an interpolation time, and the parameter regarding the contact condition may be automatically set on the basis of the estimation result.

### (F) Position Constraint Condition

The interpolation parameter may include a parameter related to a position constraint condition. The parameter related to the position constraint condition is the parameter related to fixation of the intermediate posture of the interpolation motion data C. The parameter related to the position constraint condition is the parameter for fixing the entire joint posture of the interpolation motion data C at the certain time t between t_{A} and t_{B}, and is represented by S_{c}(t).

For example, in a case where the user desires interpolation motion data for putting the knee on the ground at the certain time t between t_{A} and t_{B}, the user may set parameters of all joint postures for putting the knee on the ground at the time t as parameters related to the position constraint condition.

### (G) Semantic Conditions

The interpolation parameter may include the parameter related to a semantic condition. The parameter related to the semantic condition includes the parameter related to the style of the interpolation motion data C.

The style here is defined by the characteristic of motion of motion data, the label expressed as a genre, or the like, and the learning unit 120 can provide the parameter regarding the semantic condition by assigning the label to motion data and causing the generative model to learn.

Note that specific examples of the style include “dynamically”, “dance-like”, “jumping”, and “masculine (feminine)” and the like. Furthermore, the parameter related to the semantic condition may be given to each application, and the generation unit 241 may generate the interpolation motion data C without providing such a parameter related to the semantic condition.

### (H) Random Number or Noise

The interpolation parameter may include a parameter related to a random number or a noise. For example, the generation model that generates the interpolation motion data C may input the random number as a probabilistic generative model. By using the parameter related to the random number or noise, different interpolation motion data C can be generated even if other interpolation parameter as described above is fixed.

The generation unit 241 may generate the interpolation motion data C of various variations by inputting the random number as a seed, or may generate the interpolation motion data C without giving the random number (that is, the random number is set to the fixed value).

The specific examples of the interpolation parameter have been described above. As described above, the generation unit 241 generates the interpolation motion data C on the basis of the first motion data A, the second motion data B, and the interpolation parameter.

Furthermore, the generation unit 241 may generate the connected motion data obtained by connecting the first motion data A, the interpolation motion data C, and the second motion data. However, depending on the setting value of the interpolation parameter, there is a possibility that the respective pieces of motion data included in the generated connected motion data are not necessarily connected naturally (smoothly).

Therefore, the information processing system according to the embodiment of the present disclosure has the mechanism capable of more naturally connecting the first motion data A, the interpolation motion data C, and the second motion data B. More specifically, the calculation unit 243 calculates an index related to the motion velocity of each motion data on the basis of the first motion data A, the second motion data B, and the interpolation motion data C generated by the generation unit 241.

Next, a specific example of the index calculated by the calculation unit 243 and a specific example related to processing of presenting candidates of interpolation motion data based on the index to the user will be described.

### 3.4. Scoring

First, the generation unit 241 generates the interpolation motion data x^{C} on the basis of the first motion data x^{A}, the second motion data x^{B}, and the interpolation parameters c₀ to cₙ by using the above-described formula (1). Then, the calculation unit 243 may calculate the total index s including at least one index S by using the following formula (2).

### Math.2

s=S(x^{A}, x^{B}, x^{C}) (2)

For example, the calculation unit 243 may calculate the total index s including the five indexes S by using the following formula (3).

### Math.3

s=wₚSₚₒₛᵢₜᵢₒₙ+wᵥS_{velocity}+wⱼS_{jerky}+w_{f}S_{foot}+wₘSₘₑₜₐ (3)

In formula (3), wₚ, wᵥ, wⱼ, w_{f} and wₘ are weighting factors for each index, and may be automatically set or specified for each use case.

In addition, the total index s in formula (3) is defined by the combination of a physical index and a heuristic index. However, the index S included in the total index s is not limited to the physical index and the heuristic index described below. In addition, the index S in the total index s does not necessarily include all the indexes S described below. For example, the expression (3) may not include the term of wₘSₘₑₜₐ (meta index). First, four physical indexes in formula (3) will be described.

### Physical Index

For example, the physical index includes indexes related to the motion velocities of the first motion data A, the interpolation motion data C, and the second motion data B (hereinafter, these motion data may be expressed as each piece of motion data). The motion velocity here includes, for example, the velocity of a root joint, the velocity of another joint (for example, the velocity of the foot), or the velocity obtained by combining velocities of a plurality of joints. In addition, the indication related to the motion velocity may also include the index related to the velocity, acceleration, or position of the motion.

For example, the physical index may include a continuous position index Sₚₒₛᵢₜᵢₒₙ indicating the degree of continuation of each piece of motion data. The continuous position index Sₚₒₛᵢₜᵢₒₙ may be the index based on a difference between the maximum value of the velocity of the interpolation motion data C and the average velocity of the first motion data A and the second motion data B in a plurality of frames before and after the interpolation motion data C.

In the section for transitioning from the first motion data A to the interpolation motion data C and the section for transitioning from the interpolation motion data C to the second motion data B, in particular, if the joint position of each motion data instantaneously moves, an unnatural behavior may occur. As the index for reducing such unnatural behavior, the continuous position index Sₚₒₛᵢₜᵢₒₙ is defined, and as the value obtained by the following formula (4) is smaller, the continuous position index Sₚₒₛᵢₜᵢₒₙ is calculated to be larger.

### Math.4

Max(||v_{c}||)−||v_{AB}||→0 (4)

According to the formula (4), the continuous position indicator Sₚₒₛᵢₜᵢₒₙ is calculated to be larger as the difference between the velocity maximum value Max(||v_{C}||) of the interpolation motion data C and the average velocity ||v_{AB}|| of the first motion data A and the second motion data B in the plurality of frames before and after the interpolation motion data C becomes smaller. In other words, the fact that the continuous position index Sₚₒₛᵢₜᵢₒₙ is calculated to be large indicates the state in which the joint positions of the respective pieces of motion data are continuously moved.

In addition, the physical index may include a velocity index S_{velocity} indicating a degree of smoothness of the velocity of each motion data. The velocity index S_{velocity} may be the index based on the difference between the average velocity of the interpolation motion data C and the average velocity of the first motion data A and the second motion data B.

If the average velocity of the first motion data A and the second motion data B is greatly different from the average velocity of the interpolation motion data C, the interpolation motion data C moves suddenly faster or suddenly slower than the first motion data A or the second motion data B, so that an unnatural behavior may occur. The velocity index S_{velocity} is defined as the index for reducing such an unnatural behavior, and the velocity index S_{velocity} is calculated larger as the value obtained by the following formula (5) is smaller.

### Math.5

||Average(v_{c})||−||v_{AB}||→0 (5)

According to the formula (5), the velocity index S_{velocity} is calculated to be large when the difference between the average velocity ||Average(v_{C})|| of the interpolation motion data C and the average velocity ||v_{AB}|| of the first motion data A and the second motion data B decreases. In other words, the fact that the velocity index S_{velocity} is calculated to be large indicates a state in which each piece of motion data moves more smoothly.

In addition, the physical index may include an acceleration index S_{jerky} indicating the degree to which jerk (jerk: the rate of change in acceleration) of the interpolation motion data C is small. The acceleration index S_{jerky} may be the index based on the differential component of the acceleration of the interpolation motion data C.

In a case where the interpolation motion data C generated by the generation unit 241 suddenly accelerates or decelerates, an unnatural behavior may occur. The acceleration index S_{jerky} is defined as the index for reducing such an unnatural behavior, and the acceleration index S_{jerky} is calculated to be larger as the value obtained by the following formula (6) is smaller.

### Math.6

∫_{c}||\dot{a}_{c}||dt→0 (6)

According to formula (6), the acceleration index S_{jerky} is calculated to be large when the jerk that is the differential value of the interpolation motion data C decreases. In other words, the fact that the acceleration index S_{jerky} is calculated large indicates the state in which jerk of each motion data is small (that is, the state where the vehicle is not suddenly accelerated or decelerated).

In addition, the physical index may include a foot index S_{foot} indicating whether the foot of the interpolation motion data C does not slip at the time of grounding. The foot index S_{foot} is the index related to the velocity of the toe of the foot when the toe of the foot of the interpolation motion data C is in contact with the ground.

When the foot of the interpolation motion data C is in contact with the ground, if the magnitude of the velocity of the foot is 0 or more, the foot of the interpolation motion data C slides with respect to the ground. In many cases, sliding of the foot can be an unnatural behavior. As the index for reducing such an unnatural behavior, the foot index S_{foot} is defined, and the smaller the value obtained by the following formula (7), the larger the foot index S_{foot} is calculated.

### Math.7

∫_{c}v_{c,foot}dt→0 (7)

According to the formula (7), the foot index S_{foot} is calculated to be large in a case where the magnitude of the velocity of the foot of the interpolation motion data C decreases. In other words, the fact that the foot index S_{foot} is calculated to be large indicates a state in which the foot of the interpolation motion data C does not slip with respect to the ground.

The specific example of the physical index has been described above. Next, an example of the heuristic index included in the formula (3) will be described.

### Heuristic Index

The heuristic index may include a different meta index Sₘₑₜₐ for each use case. The meta index Sₘₑₜₐ may be the index according to the use case based on the difference between the attribute of the interpolation motion data and the attribute demanded for the interpolation motion data.

When the attribute of the interpolation motion data C generated by the generation unit 241 is greatly different from the user's sensitivity or the use case, the user may feel it unnatural. For example, in a case where the first motion data A and the second motion data B are motions performed by a woman, and the interpolation motion data C generated by the generation unit 241 is motions performed by a large man, the connected motion data obtained by connecting the motion data may have an unnatural behavior. As the index for reducing such an unnatural behavior according to the use case, a meta index Sₘₑₜₐ is defined, and when the function for determining the attribute of the interpolation motion data C is F and the desired attribute is m, the meta index Sₘₑₜₐ is calculated to be larger as the value obtained by the following formula (8) is smaller.

### Math.8

F(M_{c})−s→0 (8)

According to the formula (8), the meta index Sₘₑₜₐ is calculated to be larger as the difference between the attribute m obtained according to the use case and the attribute F(M_{c}) of the interpolation motion data C generated by the generation unit 241 is smaller. In other words, the fact that the meta index Sₘₑₜₐ is largely calculated indicates the state in which the interpolation motion data C generated by the generation unit 241 corresponds to the user's sensitivity or use case.

After the total index s as described above is calculated by the calculation unit 243, the generation unit 241 changes the value of the interpolation parameter and generates the interpolation motion data x^{c} again, and the calculation unit 243 calculates the total index s from the generated interpolation motion data x^{c} again.

Such a series of processing from the correction of the interpolation parameter to the calculation of the total index s may be repeatedly performed a plurality of times.

That is, the series of processes in which the generation unit 241 corrects the interpolation parameters and generates the interpolation motion data x^{c} again, and the calculation unit 243 calculates the total index s from the interpolation motion data x^{c} generated again by the generation unit 241 may be repeatedly performed a plurality of times.

Note that the method of calculating the physical index described above is not limited to the above-described each formula, and a more strict calculation method may be used. In addition, as the method of calculating the heuristic index, the index suitable for other use cases may be used.

Furthermore, in the calculation formulas of the physical index and the heuristic index described above, the example has been described in which the index S increases as the value obtained by the each calculation formula decreases, but formula deformation may be performed such that the index S increases as the value obtained by each calculation formula increases.

The specific example of the index calculated by the calculation unit 243 has been described above. According to the series of processing described above, a plurality of combinations of the plurality of pieces of interpolation motion data C and the score (total index or index) calculated by the plurality of pieces of motion data C are prepared.

Here, the generation unit 241 may add the interpolation motion data C whose score (total index or index) is calculated by the calculation unit 243 to a candidate list.

Then, the generation unit 241 may sort the candidate list of the interpolation motion data C in score order (more specifically, in descending order of scores), and the operation display unit 220 may display the sorted candidates of the interpolation motion data.

As a result, the user can confirm the candidates of the interpolation motion data C sorted in descending order of scores, and the convenience of the user in viewing the interpolation motion data C can be improved.

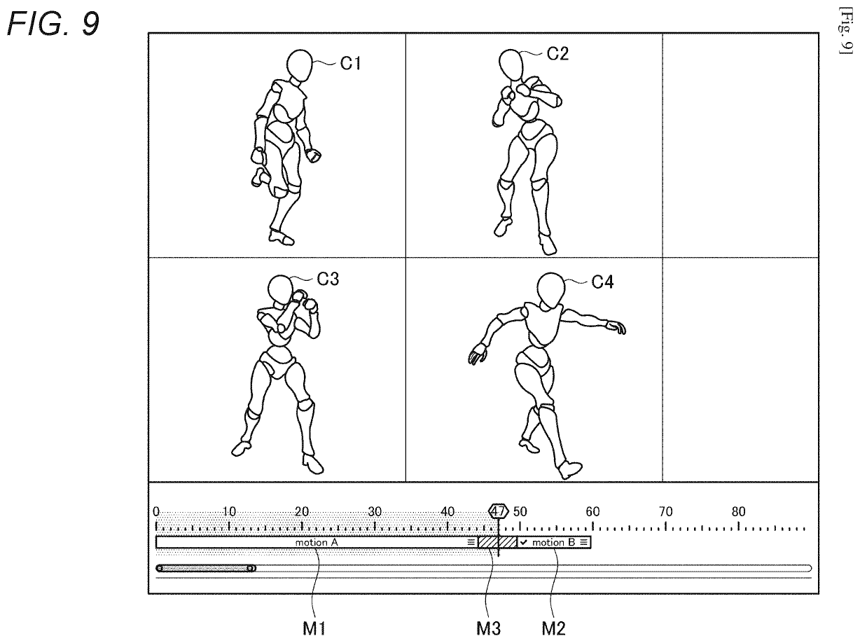

Next, an example of a graphical user interface (GUI) according to the embodiment of the present disclosure will be described with reference to FIG. 9.

### 3.5. Graphical User Interface (GUI)

FIG. 9 is an explanatory drawing for explaining an example of the GUI according to the embodiment of the present disclosure. First, the user selects the first motion data A using the operation display unit 220 and inserts the first motion data A into an arbitrary section M1 on a timeline.

Subsequently, the user selects the second motion data B using the operation display unit 220 and inserts the second motion data B into another arbitrary section M2 on the timeline. Note that the designation of the arbitrary sections M1 and M2 may be performed by the operation such as dragging and dropping, or may be performed by inputting time.

Here, the generation unit 241 sets, as the interpolation section M3, the section from the end position (i.e., the end position of the arbitrary section M1) of the first motion data A to the start position (i.e., the start position of the other arbitrary section M2) of the second motion data B.

In addition, the user may manually set some of the interpolation parameters described above using the operation display unit 220.

Then, when the user performs the operation (for example, pressing of an execution button (not illustrated) or the like) related to generation of interpolation motion data, the generation unit 241 generates interpolation motion data, and the calculation unit 243 calculates the score of the interpolation motion data generated by the generation unit 241.

And then, the generation unit 241 sorts the interpolation motion data C in order of scores, and the operation display unit 220 displays the candidate list of interpolation motion data sorted in order of the scores as illustrated in FIG. 9.

The candidate list illustrated in FIG. 9 is for the case where first interpolation motion data C1, second interpolation motion data C2, third interpolation motion data C3, and fourth interpolation motion data C4 are calculated to have higher scores in this order. In addition, in a case where the upper limit of the interpolation motion data to be included in the candidate list is set to four, four pieces of interpolation motion data C1 to C4 as illustrated in FIG. 9 are displayed on the operation display unit 220. However, for example, in a case where the upper limit of the interpolation motion data to be included in the candidate list is set to 5 or more, the user can confirm after the interpolation motion data C5 to which the score is calculated to be small by scrolling down the candidate list.

Then, when the user selects one piece of the interpolation motion data C from the candidate list, the generation unit 241 generates connected motion data obtained by connecting the first motion data A, the interpolation motion data C selected by the user, and the second motion data B.

Then, the operation display unit 220 displays the connected motion data generated by the generation unit 241.

Although an example of the GUI according to the embodiment of the present disclosure has been described above, the GUI is not limited to the above-described example. For example, the operation display unit 220 may display the connected motion data obtained by simply connecting the first motion data A and the second motion data B, the connected motion data interpolated by motion blending, or the like.

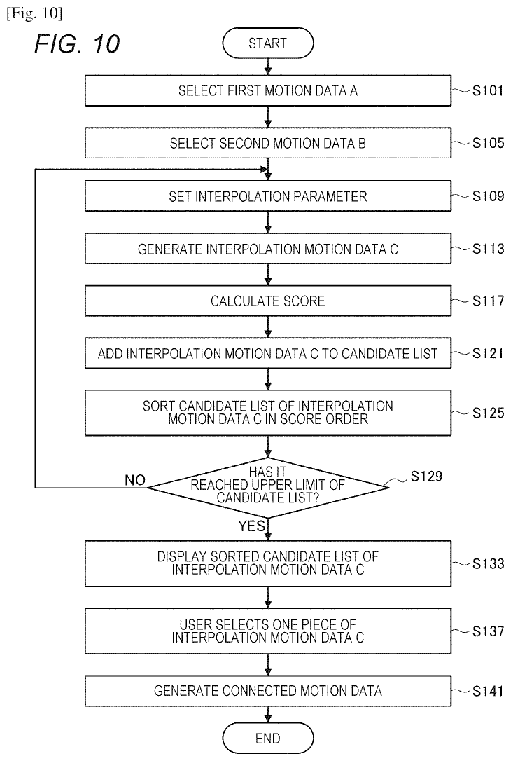

The details of the information processing system according to the embodiment of the present disclosure have been described above. Next, an example of operation processing of the PC 20 according to the embodiment of the present disclosure will be described with reference to FIG. 10.

### 4. Operation Processing Example

FIG. 10 is a flowchart for explaining an example of operation processing of the PC 20 according to the embodiment of the present disclosure. First, the user selects the first motion data A using the operation display unit 220 (S101).

Subsequently, the user selects the second motion data B using the operation display unit 220 (S105).

Next, the generation unit 241 automatically sets at least one or more interpolation parameters (S109). Here, the user may manually set some of the interpolation parameters described above using the operation display unit 220.

Then, the generation unit 241 generates the interpolation motion data C on the basis of the first motion data A and the second motion data B selected by the user and the interpolation parameters set by the generation unit 241 (or the user) (S113).

Next, the calculation unit 243 calculates the score (total index or index) on the basis of the interpolation motion data C generated by the generation unit 241 and the first motion data A and the second motion data B selected by the user (S117).

Subsequently, the generation unit 241 adds the interpolation motion data C for which the score is calculated by the calculation unit 243 to the candidate list (S121). Note that the generation unit 241 may add the interpolation motion data C whose score calculated by the calculation unit 243 is the predetermined value or more to the candidate list, and may not add the interpolation motion data C whose score is less than the predetermined value to the candidate list.

Next, the generation unit 241 sorts the candidate list of the interpolation motion data C in score order (more specifically, in descending order of scores) (S125).

Then, the generation unit 241 determines whether or not the number of pieces of interpolation motion data C added to the candidate list has reached the upper limit of the candidate list (S129). In a case where the upper limit of the candidate list has been reached (S129: YES), the processing proceeds to S133. In a case where the upper limit of the candidate list has not been reached (S129: NO), the processing returns to S109 again to reset (change) the interpolation parameter, and the processing of S109 to S129 is repeatedly performed until the upper limit of the candidate list is reached in S129. Note that the upper limit of the candidate list here corresponds to a predetermined number of times set in advance, and may be designated by the user or may be automatically set.

In a case where the number of pieces of interpolation motion data C reaches the upper limit of the candidate list (S129: YES), the operation display unit 220 displays the candidate list of the interpolation motion data C sorted in the score order (S133).

Subsequently, the user selects one piece of interpolation motion data C included in the candidate list on the operation display unit 220 (S137).

Then, the generation unit 241 generates the connected motion data obtained by interpolating the interpolation motion data C selected by the user between the first motion data A and the second motion data B (S141), and the PC 20 according to the embodiment of the present disclosure ends the processing.

### 5. Example of Action and Effect

According to the present disclosure described above, various actions and effects can be obtained. For example, the generation unit 241 according to the embodiment of the present disclosure generates the interpolation motion data C that interpolates between the first motion data A and the second motion data B that are temporally and spatially independent, and the calculation unit 243 calculates the index related to the motion velocity of each motion data on the basis of the first motion data A, the second motion data B, and the interpolation motion data C generated by the generation unit 241. This allows the user to determine the degree of more natural behavior of the connected motion data assumed when the first motion data A, the second motion data B, and the interpolation motion data C are connected. As a result, the generation unit 241 can generate the connected motion data in which a plurality of pieces of motion data is more naturally connected.

In addition, the generation unit 241 changes the interpolation parameter to generate the interpolation motion data C a plurality of times, and the calculation unit 243 calculates a score using each piece of the interpolation motion data C generated by the generation unit 241. Furthermore, the operation display unit 220 displays the candidate list of the interpolation motion data C sorted in score order. As a result, the user can easily select the interpolation motion data C desired more by the user. As a result, the user can confirm the connected motion data according to the user's wish.

### 6. Modifications

### Motion Capture Interpolation Technology

The interpolation processing by generating interpolation motion data according to the embodiment of the present disclosure can also be applied to an interpolation technique in motion capture. For example, in a case where motion is recorded by a motion capture system, there is a case where some motion is lost due to occlusion or the like.

In this instance, the generation unit 241 may set the motion before and after the lost section as the first motion data A and the second motion data B, respectively, generate the interpolation motion data C that smoothly interpolates the first motion data A and the second motion data B, and interpolate the motion in the lost section.

In this case, at the time of setting interpolation parameters, among the plurality of interpolation parameters, the interpolation parameters regarding a spatial position, interpolation time, a posture of the first motion data A, and a posture of the second motion data B are fixed. The PC 20 corrects other interpolation parameters (i.e., contact conditions, position constraint conditions, semantic conditions, random numbers, and the like) to repeatedly generate interpolation motion data and perform score calculation. Then, after the candidates of the interpolation motion data are displayed, the user designates one piece of the interpolation motion data, so that the interpolation of the lost section can be performed. Note that the user does not necessarily need to designate one piece of the interpolation motion data, and the generation unit 241 may automatically designate the interpolation motion data C calculated with the highest score or the interpolation motion data with the score exceeding the threshold, and interpolate the lost section.

It is also assumed that the motion of a part of the body (for example, a hand or the like) is lost. In this instance, the generation unit 241 may set the lost section for the part of the body (referred to as a target region).

Then, the generation unit 241 may set the motion before and after the loss of the target part as the first motion data A and the second motion data B, respectively, and generate the interpolation motion data C that smoothly interpolates the target part. As a result, the motion of the body excluding the target part obtained by the motion capture is adopted as it is, and interpolation of the target part in which the motion is lost becomes possible.

Besides, in a case where the interpolation processing of the target part is executed, the target part to be interpolated on the timeline of the application may be branched (for example, only right hand, etc.). Furthermore, there may be a plurality of target parts to which the motion is interpolated (for example, right hand+left hand, etc.).

In addition, the generation unit 241 may set the position constraint condition for each part other than the target part to be interpolated as the interpolation parameter. As a result, the interpolation motion data in which only the target part (for example, only the right hand) is interpolated while the whole body excluding the target part moves according to the motion data may be generated.

Further, the calculation unit 243 may calculate the score described above from the target region generated by the generation unit 241. In a case where there is a plurality of target parts, the calculation unit 243 may change the value of the interpolation parameter for each target part, weight each target part, and calculate the index. Then, the operation display unit 220 may display the interpolation motion data of the target part and the whole-body motion excluding the target part by connecting them.

Furthermore, in an application in a VR game or a metaverse space, the user's motion is reflected in an avatar in real time using the motion capture system. At that time, there is a case where pre-registered animation such as a hand gesture or an emotional motion is poured in a real-time motion capture.

Here, the generation unit 421 may generate the interpolation motion data C that smoothly interpolates the first motion data A and the second motion data B with the real-time motion as the first motion data A and the emotional motion as the second motion data B. This may allow for a natural transition from real-time motion to emotional motion. In addition, a new expression (for example, VR live or the like) combining the real-time motion and the pre-recorded motion becomes possible.

### Synthesis With Motion Blending

Furthermore, in the interpolation processing according to the embodiment of the present disclosure, the interpolation processing by generation of the interpolation motion data and the interpolation processing by motion blending may be used in combination. For example, the generation unit 241 may perform interpolation processing by the motion blending on the upper body of the motion data, and perform the interpolation processing by generating the interpolation motion data on the lower body.

In the motion blending, for example, the generation unit 421 may interpolate the connection position of the motion data by linearly interpolating from the interpolation start posture of the first motion data A to the interpolation end posture of the second motion data B.

### 7. Hardware Configuration Example

The embodiments of the present disclosure have been described above. Information processing such as the generation of interpolation motion data and calculation of the scores (the total index and index) described above is realized by cooperation of software and hardware of the PC 20 described below. Note that the hardware configuration described below is also applicable to the server 10.

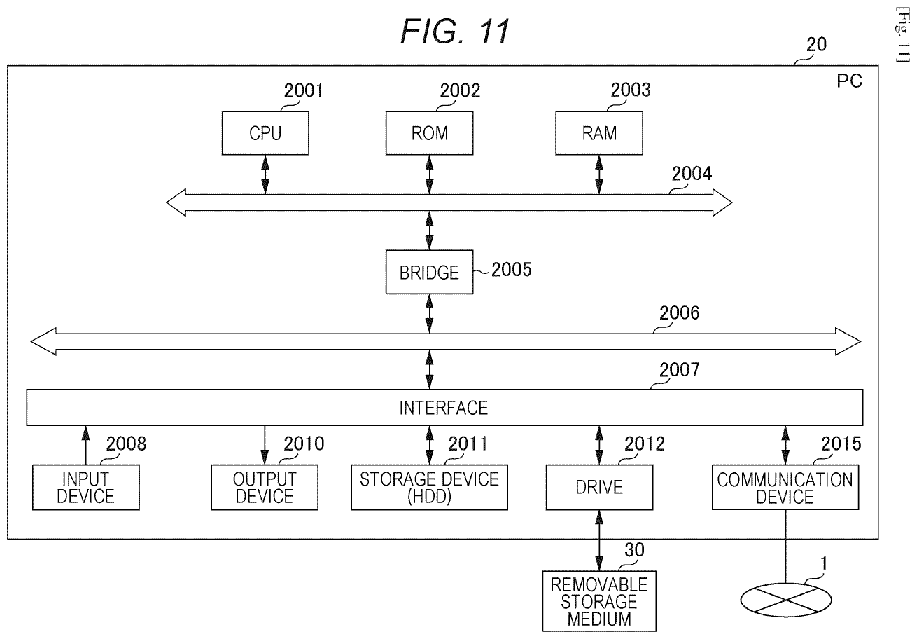

FIG. 11 is a block diagram illustrating the hardware configuration of the PC 20 according to the embodiment of the present disclosure. The PC 20 according to the embodiment of the present disclosure includes a central processing unit (CPU) 2001, a read only memory (ROM) 2002, a random access memory (RAM) 2003, and a host bus 2004. In addition, the PC 20 includes a bridge 2005, an external bus 2006, an interface 2007, an input device 2008, an output device 2010, a storage device (HDD) 2011, a drive 2012, and a communication device 2015.

The CPU 2001 functions as an arithmetic processing device and a control device, and controls the overall operation in the PC 20 according to various programs. In addition, the CPU 2001 may be a microprocessor. The ROM 2002 stores programs, calculation parameters, and the like used by the CPU 2001. The RAM 2003 temporarily stores programs used in the execution of the CPU 2001, parameters that appropriately change in the execution, and the like. These are mutually connected by the host bus 2004 including a CPU bus or the like. Functions of the generation unit 241 and the calculation unit 243 described with reference to FIG. 3 can be realized by cooperation of the CPU 2001, the ROM 2002, the RAM 2003, and software.

The host bus 2004 is connected to the external bus 2006 such as a peripheral component interconnect/interface (PCI) bus via the bridge 2005. Note that the host bus 2004, the bridge 2005, and the external bus 2006 do not necessarily need to be configured separately, and these functions may be mounted on one bus.

The input device 2008 includes input device for the user to input information, such as a mouse, a keyboard, a touch panel, a button, a microphone, a switch, and a lever, an input control circuit that generates an input signal on the basis of the input by the user and outputs the input signal to the CPU 2001, and the like. By operating the input device 2008, the user of the PC 20 can input various data to the PC 20 and instruct the PC 20 to perform a processing operation.

The output device 2010 includes, for example, a display device such as a liquid crystal display device, an OLED device, and a lamp. Furthermore, the output device 2010 includes an audio output device such as a speaker and a headphone. The output device 2010 outputs, for example, a reproduced content. Specifically, the display device displays various kinds of information such as reproduced video data as text or images. On the other hand, the audio output device converts audio data and the like into audio and outputs the audio.

The storage device 2011 is a device for storing data. The storage device 2011 may include a storage medium, a recording device that records data in the storage medium, a reading device that reads data from the storage medium, a deletion device that deletes data recorded in the storage medium, and the like. The storage device 2011 includes, for example, a hard disk drive (HDD). The storage device 2011 drives a hard disk and stores a program executed by the CPU 2001 and various data.

The drive 2012 is a reader/writer for the storage medium, and is built in or externally attached to the PC 20. The drive 2012 reads information recorded in the attached removable storage medium 30 such as a magnetic disk, an optical disk, a magneto-optical disk, or a semiconductor memory, and outputs the information to the RAM 2003. Furthermore, the drive 2012 can also write information to the removable storage medium 30.

The communication device 2015 is, for example, a communication interface including the communication device or the like for connecting to the network 1. Furthermore, the communication device 2015 may be a wireless LAN compatible communication device, a long term evolution (LTE) compatible communication device, or a wire communication device that performs wired communication.

### 8. Supplement

The preferred embodiments of the present disclosure have been described in detail above with reference to the accompanying drawings, but the present disclosure is not limited to such examples. It is obvious that a person having ordinary knowledge in the technical field to which the present disclosure belongs can conceive various changes or modifications within the scope of the technical idea described in the claims, and it is naturally understood that these also belong to the technical scope of the present disclosure.

For example, the PC 20 may further include all or some of the functional configurations of the server 10 according to the embodiment of the present disclosure. In a case where the PC 20 includes all the functional configurations of the server 10 according to the embodiment of the present disclosure, the PC 20 can execute a series of processes related to generation of the interpolation motion data and calculation of the index without performing communication via the network 1.

Furthermore, the server 10 may include the generation unit 241 and the calculation unit 243. In this case, the example process relating to generation of the interpolation motion data to calculation of the index may be performed on the server, and the result of the process (for example, the candidate list sorted in order of scores) may be transmitted to the PC 20.

In addition, in a case where the server 10 includes the generation unit, the PC 20 may acquire the interpolation motion data generated by the generation unit of the server 10 from the server 10. In this case, the communication unit 210 included in the PC 20 corresponds to the acquisition unit.

Furthermore, the software may be used as the independent application for searching and editing motion data, or the motion interpolation editing function may be used as the plug-in of an existing digital content creation (DCC) tool.

In addition, generation of the interpolation motion data and the motion blending have been exemplified as specific examples related to the interpolation editing, but the interpolation editing according to the present disclosure is not limited to such examples. For example, the generation unit 241 may interpolate the motion data by combining the interpolation editing by generation of the interpolation motion data and the interpolation editing by text search of the motion data. For example, the user may search the text of the motion data of an arbitrary part, and select one piece of motion data from a plurality of pieces of the motion data displayed as a search result. In this case, the generation unit 241 may interpolate the motion of the part using the motion data designated by the user, and may interpolate the motion of the other part by generating the interpolation motion data.

Also, depending on the combination of the first motion data A and the second motion data B, there is a possibility that the score calculated by the calculation unit 243 may not be high even if the interpolation parameter is changed. In such a case, the operation display unit 220 may present recommendation information such as whether to change the second motion data B to another piece of second motion data B′.

Furthermore, each step in the processing of the PC 20 in the present specification is not necessarily processed in the time series in the order described as the flowchart. For example, each step in the processing of the PC 20 may be processed in an order different from the order described as the flowchart.

In addition, it is also possible to create a computer program for causing the hardware such as a CPU, a ROM, and a RAM built in the server 10 and the PC 20 to exhibit functions equivalent to the respective configurations of the server 10 and the PC 20 described above. Furthermore, the storage medium storing the computer program is also provided.

Besides, the effects described in the present specification are merely illustrative or exemplary, and are not restrictive. That is, the technology according to the present disclosure can exhibit other effects obvious to those skilled in the art from the description of the present specification together with or instead of the above effects.

Note that the following configurations also belong to the technical scope of the present disclosure.

(1) An information processing device including:
circuitry configured to
obtain interpolation motion data that interpolates between first motion data and second motion data that are temporally and spatially independent, and
calculate an index related to motion velocity of each motion data based on the first motion data, the second motion data, and the obtained interpolation motion data.

(2) The information processing device according to (1), in which
the index includes an index based on a difference between an average velocity of the interpolation motion data and average velocities of the first motion data and the second motion data.

(3) The information processing device according to (1) or (2), in which
the index includes a first index based on a difference between a maximum value of velocities of the interpolation motion data and an average velocity of a plurality of frames including the first motion data before the interpolation motion data, and
the index further includes a second index based on a difference between the maximum value of the velocities of the interpolation motion data and an average velocity of a plurality of frames including the second motion data after the interpolation motion data.

(4) The information processing device according to any one of (1) to (3), in which
the index includes an index based on a differential component of acceleration of the interpolation motion data.

(5) The information processing device according to any one of (1) to (4), in which
the index includes an index related to a velocity of a toe of a foot when the toe of the foot of the interpolation motion data is in contact with a ground.

(6) The information processing device according to any one of (1) to (5), in which
the circuitry is further configured to calculate an index according to a use case based on a difference between an attribute of the interpolation motion data and an attribute demanded for the interpolation motion data based on at least one condition of the use case.

(7) The information processing device according to (6), in which
the circuitry is further configured to calculate a total index by calculating a plurality of indexes related to a velocity and a plurality of indexes related to a use case of each motion data, multiplying each of the plurality of indexes by a weighting factor, and adding the plurality of indexes.

(8) The information processing device according to (7), in which
the circuitry obtains the interpolation motion data based on the first motion data and the second motion data.

(9) The information processing device according to (8), in which
the circuitry obtains the interpolation motion data based on the first motion data, the second motion data, and at least one interpolation parameter related to motion.

(10) The information processing device according to (9), in which
the circuitry obtains the interpolation motion data by using a generative model obtained by learning a relationship between two temporally and spatially independent motion data, the interpolation parameter, and the at least one interpolation motion data.

(11) The information processing device according to (10), in which
the circuitry is further configured to modify the at least one interpolation parameter to obtain the interpolation motion data a plurality of times, and
the circuitry calculates the total index from each of a plurality of pieces of the obtained interpolation motion data.

(12) The information processing device according to any one of (9) to (11), in which
the at least interpolation parameter includes a plurality of interpolation parameters, and one or more interpolation parameters included in the plurality of interpolation parameters are automatically set based on a difference between velocity of a root joint of the first motion data and a velocity of the root joint of the second motion data, or a difference between a spatial position of the root joint of the first motion data and a spatial position of the root joint of the second motion data.

(13) The information processing device according to (11), in which
the circuitry is further configured to acquire a candidate list of interpolation motion data according to a size of the total index.

(14) The information processing device according to (13), in which
the circuitry acquires the candidate list where the interpolation motion data is sorted in an order according to a size of the total index.

(15) The information processing device according to (14), in which
the circuitry modifies the at least one interpolation parameter over a preset predetermined number of times to acquire the predetermined number of pieces of interpolation motion data, and acquires the candidate list of interpolation motion data with the predetermined number of pieces of the interpolation motion data sorted in descending order of the total index.

(16) The information processing device according to any one of (13) to (15), in which
the circuitry is further configured to obtain sequentially connected motion data obtained by sequentially connecting the first motion data, the second motion data, and the interpolation motion data.

(17) The information processing device according to (16), in which
the circuitry obtains the sequentially connected motion data obtained by connecting the first motion data, the second motion data, and at least one piece of interpolation motion data selected by a user from the candidate list.

(18) An information processing method executed by a computer, the method including:
obtaining interpolation motion data interpolating between temporally and spatially independent first motion data and second motion data; and
calculating an index related to motion velocity of each motion data based on the first motion data, the second motion data, and the obtained interpolation motion data.

(19) A non-transitory computer-readable storage medium having embodied thereon a program, which when executed by a computer causes the computer to execute a method, the method including:
obtaining interpolation motion data that interpolates between temporally and spatially independent first motion data and second motion data; and
calculating an index related to motion velocity of each motion data based on the first motion data, the second motion data, and the obtained interpolation motion data.

It should be understood by those skilled in the art that various modifications, combinations, sub-combinations and alterations may occur depending on design requirements and other factors insofar as they are within the scope of the appended claims or the equivalents thereof.

### Reference Signs List

1 Network

10 Server

110 Storage unit

120 Learning unit

130 Communication unit

20 PC

210 Communication unit

220 Operation display unit

230 Storage unit

240 Control unit

241 Generation unit

243 Calculation unit

1. An information processing device comprising:
circuitry configured to
obtain interpolation motion data that interpolates between first motion data and second motion data that are temporally and spatially independent, and
calculate an index related to motion velocity of each motion data based on the first motion data, the second motion data, and the obtained interpolation motion data.

2. The information processing device according to claim 1, wherein
the index includes an index based on a difference between an average velocity of the interpolation motion data and average velocities of the first motion data and the second motion data.

3. The information processing device according to claim 1,
wherein the index includes a first index based on a difference between a maximum value of velocities of the interpolation motion data and an average velocity of a plurality of frames including the first motion data before the interpolation motion data, and
wherein the index further include a second index based on a difference between the maximum value of the velocities of the interpolation motion data and an average velocity of a plurality of frames including the second motion data after the interpolation motion data.

4. The information processing device according to claim 1, wherein
the index includes an index based on a differential component of acceleration of the interpolation motion data.

5. The information processing device according to claim 1, wherein
the index includes an index related to a velocity of a toe of a foot when the toe of the foot of the interpolation motion data is in contact with a surface.

6. The information processing device according to claim 1, wherein
the circuitry is further configure to calculate an index according to a use case based on a difference between an attribute of the interpolation motion data and an attribute demanded for the interpolation motion data based on at least one condition of the use case.

7. The information processing device according to claim 6, wherein
the circuitry is further configured to calculate a total index by calculating a plurality of indexes related to a velocity and a plurality of indexes related to the use case of each motion data, multiplying each of the plurality of indexes by a weighting factor, and adding the plurality of indexes.

8. The information processing device according to claim 7, wherein
the circuitry obtains the interpolation motion data based on the first motion data and the second motion data.

9. The information processing device according to claim 8, wherein
the circuitry obtains the interpolation motion data based on the first motion data, the second motion data, and at least one interpolation parameter related to motion.

10. The information processing device according to claim 9, wherein
the circuitry obtains the interpolation motion data by using a generative model obtained by learning a relationship between two temporally and spatially independent motion data, the at least one interpolation parameter, and the interpolation motion data.

11. The information processing device according to claim 10, wherein
the circuitry is further configured to modify the at least one interpolation parameter to obtain the interpolation motion data a plurality of times, and
the circuitry calculates the total index from each of a plurality of pieces of the obtained interpolation motion data.

12. The information processing device according to claim 9, wherein
the at least interpolation parameter includes a plurality of interpolation parameters, and
one or more interpolation parameters included in the plurality of interpolation parameters are automatically set based on
a difference between a velocity of a root joint of the first motion data and a velocity of the root joint of the second motion data, or
a difference between a spatial position of the root joint of the first motion data and a spatial position of the root joint of the second motion data.

13. The information processing device according to claim 11, wherein
the circuitry is further configured to acquire a candidate list of interpolation motion data according to a size of the total index.

14. The information processing device according to claim 13, wherein
the circuitry acquires the candidate list in which the interpolation motion data is sorted in an order according to a size of the total index.

15. The information processing device according to claim 14, wherein
the circuitry
modifies the at least one interpolation parameter over a preset predetermined number of times to acquire the predetermined number of pieces of interpolation motion data, and
acquires the candidate list of interpolation motion data with the predetermined number of pieces of the interpolation motion data sorted in descending order of the total index.

16. The information processing device according to claim 13, wherein
the circuitry is further configured to obtain sequentially connected motion data obtained by sequentially connecting the first motion data, the second motion data, and the interpolation motion data.

17. The information processing device according to claim 16, wherein
the circuitry obtains the sequentially connected motion data obtained by connecting the first motion data, the second motion data, and at least one piece of interpolation motion data selected by a user from the candidate list.

18. An information processing method executed by a computer, the method comprising:
obtaining interpolation motion data interpolating between temporally and spatially independent first motion data and second motion data; and
calculating an index related to motion velocity of each motion data based on the first motion data, the second motion data, and the obtained interpolation motion data.

19. A non-transitory computer-readable storage medium having embodied thereon a program, which when executed by a computer causes the computer to execute a method, the method comprising:
obtaining interpolation motion data that interpolates between temporally and spatially independent first motion data and second motion data; and
calculating an index related to motion velocity of each motion data based on the first motion data, the second motion data, and the obtained interpolation motion data.
